(19) United States
(12) Patent Application Publication
(10) Pub. No.: US 2025/0366527 A1
(43) Pub. Date: Dec. 4, 2025

(54) AEROSOL-GENERATING DEVICE

(71) Applicant: KT&G CORPORATION, Daejeon (KR)

(72) Inventors: Yonghwan KIM, Anyang-si Gyeonggi-do (KR); Hwikyeong AN, Seoul (KR); Youngbum KWON, Yongin-si Gyeonggi-do (KR); Dongsung KIM, Seoul (KR)

(73) Assignee: KT&G CORPORATION, Daejeon (KR)

(21) Appl. No.: 19/096,330

(22) Filed: Mar. 31, 2025

(30) Foreign Application Priority Data
May 30, 2024 (KR) 10-2024-0070504

(51) Int. Cl. A24F 40/51; A24F 40/20; A24F 40/53

(52) U.S. Cl. CPC A24F 40/51; A24F 40/20; A24F 40/53

(57) ABSTRACT

Disclosed is an aerosol-generating device. The aerosol-generating device includes a body having an insertion space, an optical sensor disposed adjacent to the insertion space, and a controller configured to calibrate the optical sensor based on color information output from the optical sensor, wherein the controller is configured to compare the color information output from the optical sensor with a preset sensing range, and determine intensity of output light from the optical sensor such that the color information output from the optical sensor is within the sensing range.

### CROSS-REFERENCE TO RELATED APPLICATION

Pursuant to 35 U.S.C. § 119 (a), this application claims the benefit of earlier filing date and right of priority to Korean Patent Application No. 10-2024-0070504, filed on May 30, 2024, the contents of which are hereby incorporated by reference herein in its entirety.

### BACKGROUND OF THE DISCLOSURE

### 1. Field of the Disclosure

The present disclosure relates to an aerosol-generating device.

### 2. Description of the Related Art

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various studies on an aerosol-generating device have been conducted.

In an aerosol-generating device provided with an optical sensor, the optical sensor may detect a stick or a cartridge that is received in the device. The optical sensor may continuously emit light for sensing. The optical sensor may be continuously exposed to heat generated during a process of generating aerosols.

The optical sensor may age due to continuous light emission and heat exposure. For example, the optical sensor may be discolored or colored. As a result, the sensitivity of the optical sensor may decrease, and the optical sensor may not accurately detect the stick or the cartridge.

### SUMMARY OF THE DISCLOSURE

It is an object of the present disclosure to solve the above and other problems.

It is another object of the present disclosure to provide an aerosol-generating device that calibrates the intensity of output light from an optical sensor such that color information output from the optical sensor is within a set sensing range.

It is still another object of the present disclosure to provide an aerosol-generating device that calibrates the intensity of the output light from the optical sensor such that the intensity of the output light is maximized within a range where the color information output from the optical sensor is equal to or less than the upper limit of the sensing range.

It is still another object of the present disclosure to provide an aerosol-generating device that calibrates the intensity of the output light such that light intensity information of each of a plurality of colors output from the optical sensor is equal to or less than the upper limit of the sensing range.

It is still another object of the present disclosure to provide an aerosol-generating device that calibrates the intensity of the output light based on the color information output from the optical sensor in response to light reflected from each of a plurality of sticks with different reflectances.

It is still another object of the present disclosure to provide an aerosol-generating device that identifies the type of a stick received in the device based on the ratio in the light intensity information between the plurality of colors output from the optical sensor.

In accordance with an aspect of the present disclosure for accomplishing the above objects, an aerosol-generating device includes a body having an insertion space, an optical sensor disposed adjacent to the insertion space, and a controller configured to calibrate the optical sensor based on color information output from the optical sensor, wherein the controller is configured to compare the color information output from the optical sensor with a preset sensing range, and determine intensity of output light from the optical sensor such that the color information output from the optical sensor is within the sensing range.

### BRIEF DESCRIPTION OF THE DRAWINGS

FIGS. 1 to 4 are views showing aerosol-generating devices according to various embodiments of the present disclosure;

FIGS. 5 and 6 are views showing an optical sensor included in an aerosol-generating device according to an embodiment of the present disclosure;

FIG. 7 is a flowchart showing calibration of the optical sensor of the aerosol-generating device according to the embodiment of the present disclosure;

FIGS. 8 and 9 are graphs showing calibration of the optical sensor taking into account multiple color information in the aerosol-generating device according to the embodiment of the present disclosure;

FIG. 10 is a graph showing calibration of the optical sensor taking into account color information of a plurality of sticks in the aerosol-generating device according to the embodiment of the present disclosure;

FIG. 11 is a graph showing calibration of the optical sensor without a stick inserted in the aerosol-generating device according to the embodiment of the present disclosure;

FIG. 12 is a graph showing a decrease in the sensitivity of the sensor depending on calibration or non-calibration of the optical sensor in the aerosol-generating device according to the embodiment of the present disclosure; and

FIG. 13 is a block diagram of the aerosol-generating device according to the embodiment of the present disclosure.

### DETAILED DESCRIPTION OF THE PREFERRED EMBODIMENTS

Hereinafter, the embodiments disclosed in the present specification will be described in detail with reference to the accompanying drawings, and the same or similar elements are denoted by the same reference numerals Even if they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Throughout this specification, the directions of an aerosol-generating device 1 may be defined based on an orthogonal coordinate system. In the orthogonal coordinate system, an x-axis direction may be defined as a leftward-rightward direction of the aerosol-generating device 1. A y-axis direction may be defined as a forward-backward direction of the aerosol-generating device 1. A z-axis direction may be defined as an upward-downward direction of the aerosol-generating device 1.

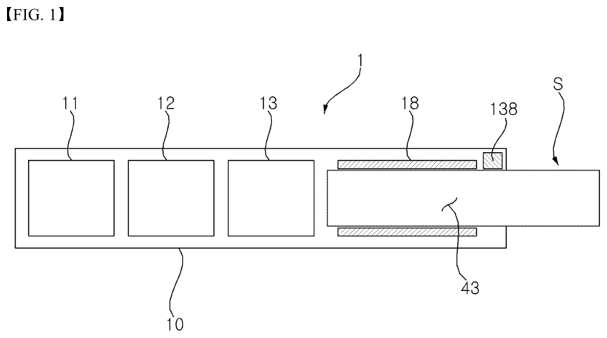

Throughout this specification, “upstream” and “downstream” may be determined based on the direction of an airflow formed such that a generated aerosol is drawn into a user's mouth or lungs when the user inhales. For example, in FIGS. 1 to 3, since the generated aerosol flows from a part of a stick S inserted into the aerosol-generating device to a part of the stick S not inserted into the aerosol-generating device, the part of the stick S inserted into the aerosol-generating device is located upstream of the part of the stick S not inserted into the aerosol-generating device. “Upstream” and “downstream” may be determined relative to components.

FIGS. 1 to 4 are views showing aerosol-generating devices 1 according to various embodiments of the present disclosure.

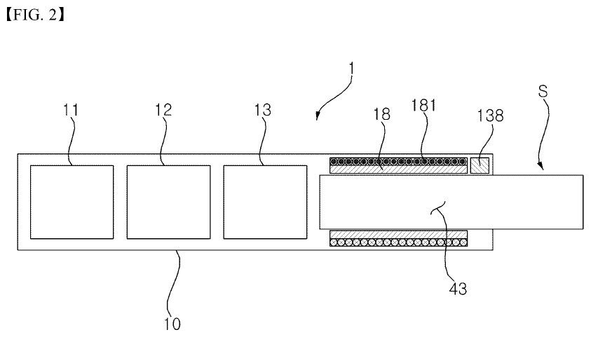

Referring to FIGS. 1 and 2, an aerosol-generating device 1 according to an embodiment may include at least one of a power supply 11, a controller 12, a sensor 13, or a heater 18. At least one of the power supply 11, the controller 12, the sensor 13, or the heater 18 may be disposed in a body 10 of the aerosol-generating device. The body 10 may define an insertion space 43 having an open top to allow a stick S, which is an aerosol-generating article, to be inserted thereinto. The insertion space 43 may be formed so as to be depressed to a predetermined depth toward the interior of the body 10 so that the stick S is inserted at least partway thereinto. The depth of the insertion space 43 may correspond to the length of the portion of the stick S that contains an aerosol-generating substance and/or medium. The lower end of the stick S may be inserted into the body 10, and the upper end of the stick S may protrude to the outside of the body 10. A user may inhale air in a state of holding the upper end of the stick S, which is exposed to the outside, in the mouth.

The heater 18 may heat a stick S. The heater 18 may be disposed around a space into which the stick S is inserted and may be elongated upward. For example, the heater 18 may be formed in a shape of a tube including a cavity formed therein. The heater 18 may be disposed around an insertion space 43. The heater 18 may be disposed so as to surround at least a portion of the insertion space 43. The heater 18 may heat the insertion space 43 or the stick S inserted into the insertion space 43. The heater 18 may include an electro-resistive heater and/or an induction heater.

For example, referring to FIG. 1, the heater 18 may be a resistive heater. For example, the heater 18 may include an electrically conductive track and may be heated as current flows through the electrically conductive track. The heater 18 may be electrically connected to the power supply 11. The heater 18 may directly generate heat using current received from the power supply 11.

For example, referring to FIG. 2, the aerosol-generating device may include an induction coil 181 surrounding the heater 18. The induction coil 181 may cause the heater 18 to generate heat. The heater 18 may generate heat using a magnetic field generated by alternating current flowing through the induction coil 181. The magnetic field may pass through the heater 18 to generate an eddy current in the heater 18. The current may cause the heater 18 to generate heat.

Meanwhile, a susceptor may be included in the stick S, and the susceptor in the stick S may generate heat using a magnetic field generated by alternating current flowing through the induction coil 181.

Meanwhile, the heater 18 may be elongated upward in the space into which the stick S is inserted. For example, the heater 18 may include a tube-type heating element, a plate-type heating element, a needle-type heating element, or a rod-type heating element. The heater 18 may be inserted into a lower portion of the stick S.

The power supply 11 may supply power so that components of the aerosol-generating device operate. The power supply 11 may be referred to as a battery. The power supply 11 may supply power to at least one of the controller 12, the sensor 13, or the heater 18. If the aerosol-generating device 1 includes the induction coil 181, the power supply 11 may supply power to the induction coil 181.

The controller 12 may control overall operation of the aerosol-generating device. The controller may be mounted on a printed circuit board (PCB). The controller 12 may control operation of at least one of the power supply 11, or the sensor 13. The controller 12 may control operation of a display, a motor, etc. mounted in the aerosol-generating device. The controller 12 may check the state of each of the components of the aerosol-generating device and may determine whether the aerosol-generating device is in an operable state.

The controller 12 may analyze a result of detection by the sensor 13 and may control subsequent processes. For example, the controller 12 may control, based on a result of detection by the sensor 13, power supplied to the heater 18 so that operation of the heater 18 commences or ends. For example, the controller 12 may control, based on a result of detection by the sensor 13, the amount of power supplied to the heater 18 and a power supply time so that the heater 18 is heated to a predetermined temperature or is maintained at an appropriate temperature.

The sensor 13 may include at least one of a temperature sensor, a puff sensor, or an insertion detection sensor. For example, the sensor 13 may detect at least one of the temperature of the heater 18, the temperature of the power supply 11, or the internal/external temperature of the body 10. For example, the sensor 13 may detect a user puff. For example, the sensor 13 may detect whether the stick S is inserted into the insertion space 43.

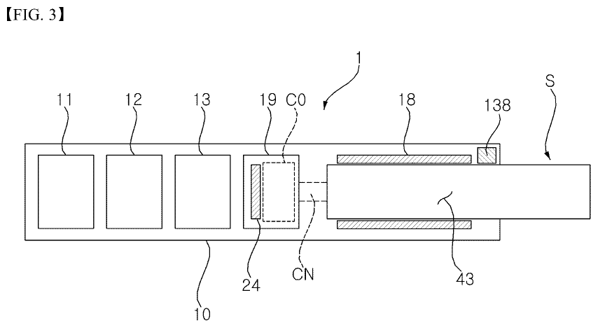

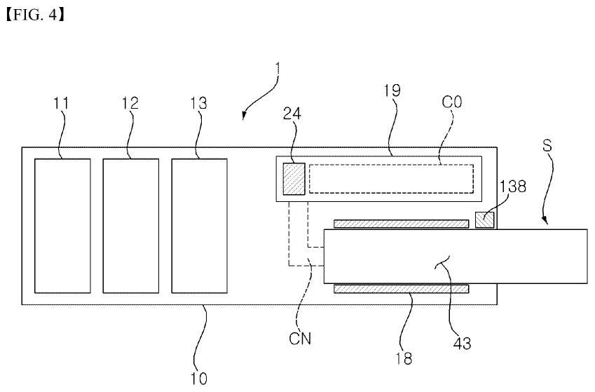

Referring to FIGS. 3 and 4, an aerosol-generating device 1 according to embodiments of the present disclosure may include at least one of a power supply 11, a controller 12, a sensor 13, a heater 18, or a cartridge 19. At least one of the power supply 11, the controller 12, the sensor 13 or the heater 18 may be disposed in a body 10 of the aerosol-generating device. The body 10 may define an insertion space 43 having an open top to allow a stick S, to be inserted thereinto. The lower end of the stick S may be inserted into the body 10, and the upper end of the stick S may protrude to the outside of the body 10. A user may inhale air in a state of holding the upper end of the stick S, which is exposed to the outside, in the mouth.

The heater 18 may heat a stick S. The heater 18 may include an electro-resistive heater and/or an induction heater.

For example, the heater 18 may be a resistive heater. For example, the aerosol-generating device may include an induction coil surrounding the heater 18. The induction coil may cause the heater 18 to generate heat. Meanwhile, a susceptor may be included in the stick S, and the susceptor in the stick S may generate heat using a magnetic field generated by alternating current flowing through the induction coil.

The cartridge 19 may contain therein an aerosol-generating substance in a liquid state, a solid state, a gas state, or a gel state. The aerosol-generating substance may include a liquid composition. For example, the liquid composition may be a liquid including a tobacco-containing material having a volatile tobacco flavor component or may be a liquid including a non-tobacco material.

The cartridge 19 may be integrally formed with the body 10 or may be detachably coupled to the body 10.

For example, referring to FIG. 3, the cartridge 19 may be integrally formed with the body 10 and may communicate with the insertion space through a gasflow channel CN.

For example, referring to FIG. 4, a space may be defined in one side of the body 10, and the cartridge 19 may be mounted in the body 10 in such a manner that at least a portion of the cartridge 19 is inserted into the space defined in one side of the body 10. The gasflow channel CN may be defined by a portion of the cartridge and/or a portion of the body 10, and the cartridge 19 may communicate with the insertion space 43 through the gasflow channel CN.

The body 10 may be formed in a structure that allows outside air to be introduced into the body 10 in a state in which the cartridge 19 is inserted thereinto. In this case, the outside air introduced into the body 10 may pass through the cartridge 19 to enter the user's mouth.

The cartridge 19 may include a storage portion CO containing an aerosol-generating substance and/or a heater 24 configured to heat the aerosol-generating substance in the storage portion CO. A liquid delivery element impregnated with (containing) the aerosol-generating substance may be disposed in the storage portion CO. Here, the liquid delivery element may include a wick, such as cotton fiber, ceramic fiber, glass fiber, or porous ceramic. The electrically conductive track of the heater 24 may be formed in a coil-shaped structure that is wound around the liquid delivery element or a structure that is in contact with one side of the liquid delivery element. The heater 24 may be referred to as a cartridge heater 24.

The cartridge 19 may generate an aerosol. As the liquid delivery element is heated by the cartridge heater 24, an aerosol may be generated. An aerosol may be generated by heating the stick S using the heater 18. While the aerosol generated by the cartridge heater 24 and the heater 18 passes through the stick S, the aerosol may be mixed with a tobacco material, and the aerosol mixed with the tobacco material may be drawn into the user's mouth through one end of the stick S.

The aerosol-generating device 1 may be provided only with the cartridge heater 24, and the body 10 may not be provided with the heater 18. In this case, while the aerosol generated by the cartridge heater 24 passes through the stick S, the aerosol may be mixed with a tobacco material, and the aerosol mixed with the tobacco material may be drawn into the user's mouth.

The aerosol-generating device 1 may include a cap (not shown). The cap may be detachably coupled to the body 10 so as to cover at least a portion of the cartridge 19 coupled to the body 10. The stick S may be inserted into the body 10 through the cap.

The power supply 11 may supply power so that components of the aerosol-generating device operate. The power supply 11 may supply power to at least one of the controller 12, the sensor 13, the cartridge heater 24 or the heater 18. The power supply 11 may supply power to the induction coil.

The controller 12 may control overall operation of the aerosol-generating device. The controller 12 may control operation of at least one of the power supply 11, the sensor 13, the heater 18 or the cartridge 19.

The controller 12 may analyze a result of detection by the sensor 13 and may control subsequent processes. For example, the controller 12 may control, based on a result of detection by the sensor 13, power supplied to the cartridge heater 24 and/or the heater 18 so that operation of the cartridge heater 24 and/or the heater 18 commences or ends. For example, the controller 12 may control, based on a result of detection by the sensor 13, the amount of power supplied to the cartridge heater 24 and/or the heater 18 and a power supply time so that the cartridge heater 24 and/or the heater 18 is heated to a predetermined temperature or is maintained at an appropriate temperature.

The sensor 13 may include at least one of a temperature sensor, a puff sensor, an insertion detection sensor, a color sensor, a cartridge detection sensor, or a cap detection sensor. For example, the sensor 13 may detect whether the cartridge is mounted. For example, the sensor 13 may detect whether the cap is mounted.

Referring to FIGS. 1 to 4, the aerosol-generating device 1 may include an optical sensor 138. The optical sensor 138 may be disposed adjacent to the insertion space 43. The optical sensor 138 may be oriented toward the insertion space 43. The optical sensor 138 may emit light toward the insertion space 43 and may receive reflected light, which is at least a part of the emitted light. The optical sensor 138 may acquire information about color from the received light. The controller 12 may be electrically connected to the optical sensor 138. The controller 12 may determine whether the stick S is inserted into the insertion space 43 and may identify at least one of the types of stick S that is inserted based on a signal output from the optical sensor 138.

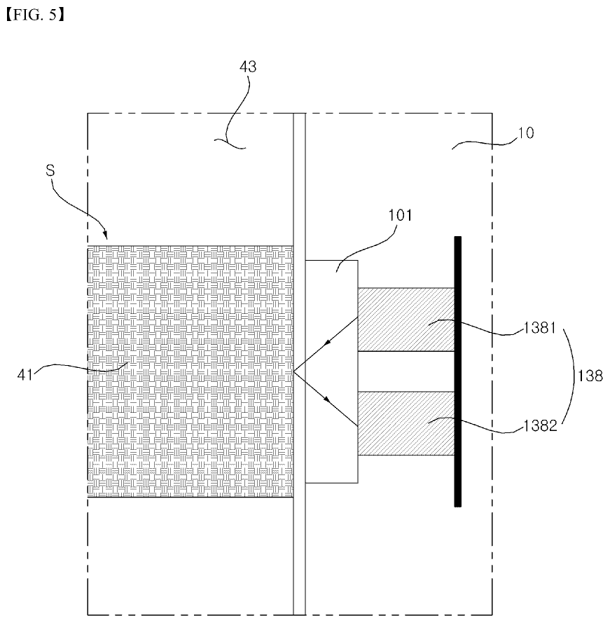

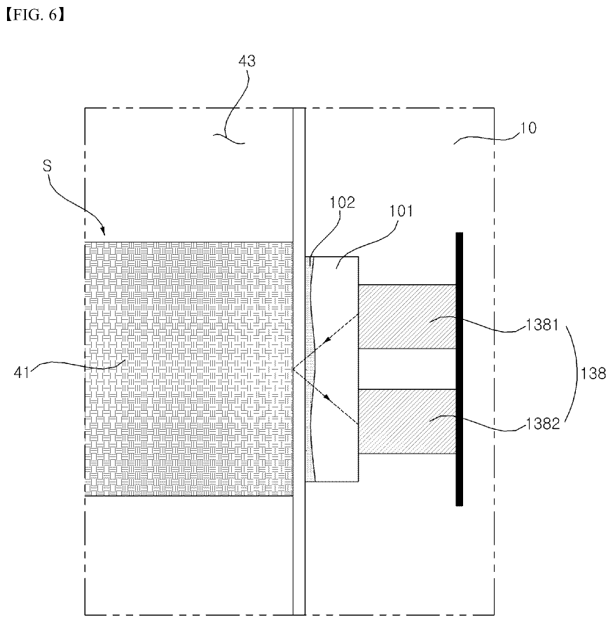

FIGS. 5 and 6 are views showing an optical sensor included in an aerosol-generating device according to an embodiment of the present disclosure.

Referring to FIG. 5, the stick S may be received in or inserted into the insertion space 43. The stick S may include an indicator 41. The indicator 41 may be formed on an outer paper or a wrapper of the stick S. The indicator 41 may be printed on a part of the outer paper or the wrapper, or may be printed so as to extend in a circumferential direction of the outer paper or the wrapper. The indicator 41 may be located on the surface of at least a part of the stick S that is inserted into the insertion space 43. The indicator 41 may have different light reflectances depending on the type of stick S. For example, the light reflectances of R, G, and B in the indicator of a first stick may be different from the light reflectances of R, G, and B in the indicator of a second stick, which is different from the first stick.

The aerosol-generating device 1 may include an optical sensor 138. The optical sensor 138 may include a light emitting portion 1381 and a light receiving portion 1382. The light emitting portion 1381 may emit light toward the insertion space 43. The light emitting portion 1381 may emit one of ultraviolet light, infrared light, and white light. The light emitting portion 1381 may be an LED. The light emitting portion 1381 may be referred to as a light source. Light emitted from the light emitting portion 1381 may be reflected from the insertion space 43 and/or from the stick S received in the insertion space 43.

The reflected light may reach the light receiving portion 1382. The light receiving portion 1382 may detect light reflected from an object. The light receiving portion 1382 may be a photodiode. The light receiving portion 1382 may acquire information about color (hereinafter referred to as color information) from the detected light. The light receiving portion 1382 may output color information corresponding to the color of the detected light.

The light receiving portion 1382 may receive light reflected from the stick S while the stick S is inserted into the insertion space 43 and may output color information corresponding to the color of the received light. The light receiving portion 1382 may receive light reflected from the insertion space 43 while the stick S is not inserted into the insertion space 43 and may output color information corresponding to the color of the received light. The color information may include light intensity values or the gray levels corresponding to a plurality of colors. The light receiving portion 1382 may output a light intensity value or a gray level corresponding to the color of the detected light. For example, the light receiving portion 1382 may output red, green, and blue values corresponding to the color of the detected light.

The light intensity value or the gray level may be expressed in 16 bits. The light intensity value or the gray level may have any value between 0 and 65535. The light intensity value or the gray level may have any value between −32768 and 32767. However, the light intensity value or the gray level may vary depending on the resolution of the sensor required by the aerosol-generating device 1.

The body 10 or the optical sensor 138 may be provided with a lens 101. The lens 101 may cover the light emitting portion 1381 and the light receiving portion 1382. The light emitting portion 1381 and the light receiving portion 1382 may be disposed side by side in a direction in which the insertion space 43 extends. The lens 101 may be disposed between the light emitting portion 1381 and the light receiving portion 1382 and the insertion space 43. The lens 101 may transmit light emitted from the light emitting portion 1381. The lens 101 may transmit light reflected from an object to the light receiving portion 1382.

The controller 12 may identify the stick S received in the insertion space 43 based on the color information output from the optical sensor 138. The color information output from the optical sensor 138 may include light intensity values corresponding to a plurality of colors. The controller 12 may determine the relative ratio between light intensity values corresponding to the plurality of colors based on the color information, and may identify the stick S received in the insertion space 43 based on the determined ratio.

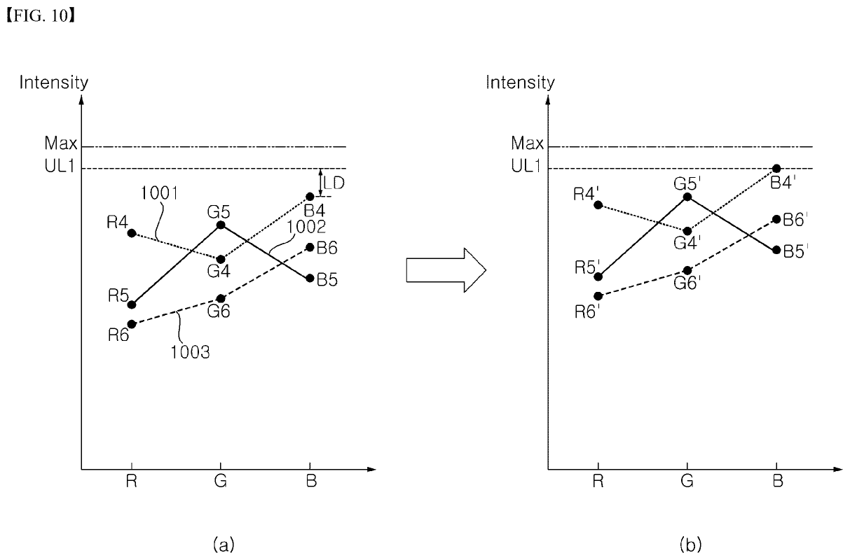

The stick S may include a plurality of sticks with different reflectances for the plurality of colors. For example, the stick S may include a first stick, a second stick, and a third stick, which may have different reflectances for the plurality of colors included in the color information (see FIG. 10). The first stick may have higher reflectances in the order of blue, red, and green. The second stick may have higher reflectances in the order of green, blue, and red. The third stick may have higher reflectances in the order of blue, green, and red. The first to third sticks may differ from other sticks in the ratio of the red light intensity value to the green light intensity value and the ratio of the blue light intensity value to the green light intensity value based on the light intensity value of the reflected light.

The controller 12 may identify the type of stick that is received in the insertion space 43 among the plurality of sticks based on the determined ratio. The controller 12 may control the power supplied to the heater 18 based on the identified type of the stick.

Accordingly, it is possible to accurately identify the stick received in the device.

Referring to FIG. 6, the light source 1381 of the optical sensor 138 may repeatedly emit light for sensing. In the process of generating aerosols, the optical sensor 138 may be continuously exposed to heat generated by the heater 18, the heat emitted from the stick S, and high-temperature aerosols flowing in the insertion space 43.

The optical sensor 138 may degrade due to continuous light emission and heat exposure. For example, at least a part 102 of the lens 101 may be discolored or colored. As a result, the sensitivity of the optical sensor 138 may decrease, and the optical sensor 138 may not be able to accurately detect the stick S, etc.

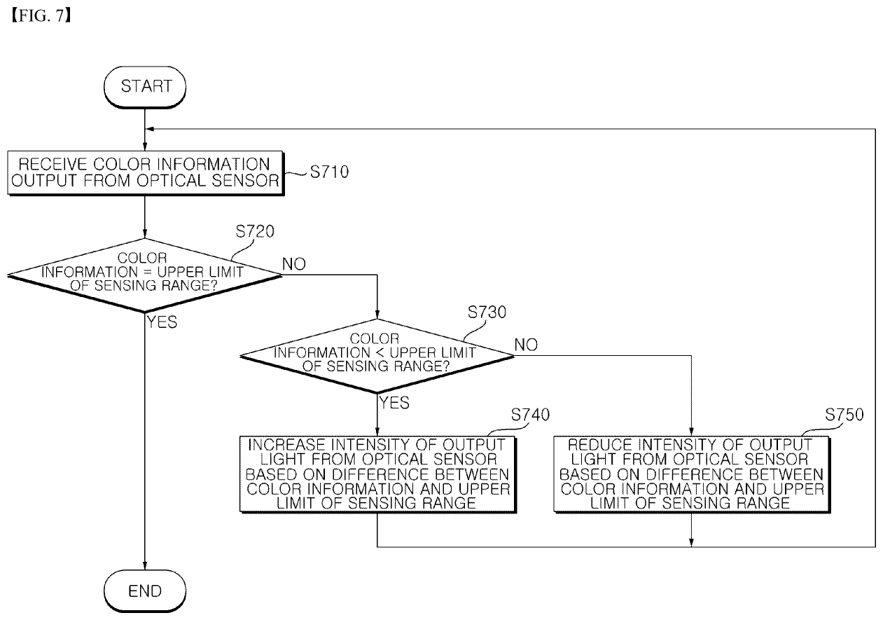

In the aerosol-generating device according to the embodiment of the present disclosure, the degradation in sensitivity of the optical sensor 138 may be prevented or minimized by adjusting the intensity of the output light from the optical sensor 138 based on the color information output from the optical sensor 138. The adjustment of the output light intensity of the optical sensor 138 will be described in detail with reference to FIGS. 7 to 12.

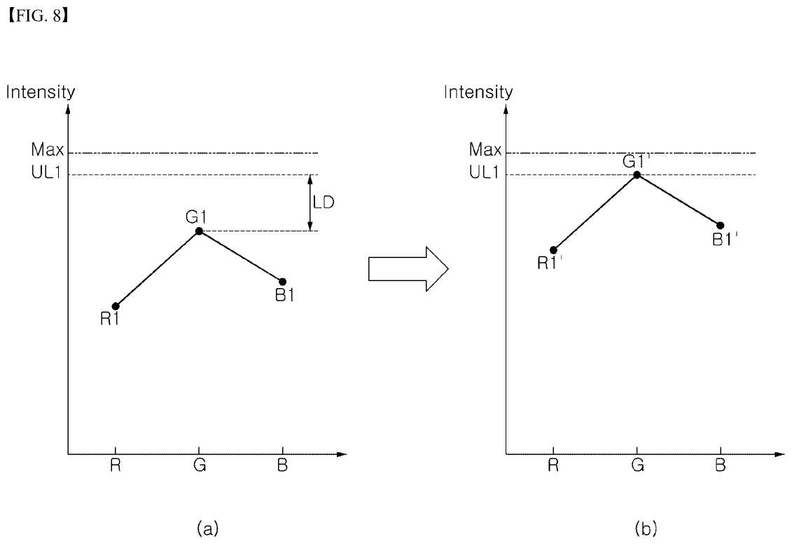

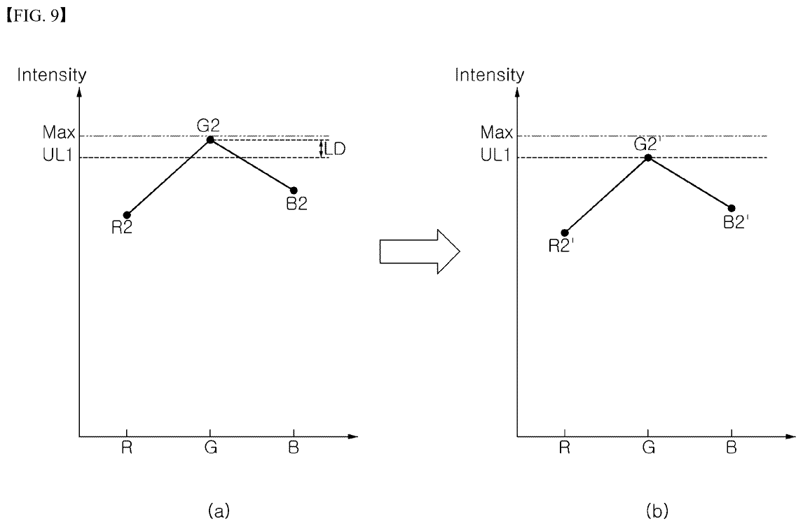

FIG. 7 is a flowchart showing calibration of the optical sensor of the aerosol-generating device according to the embodiment of the present disclosure, and FIGS. 8 and 9 are graphs showing calibration of the optical sensor taking into account multiple color information in the aerosol-generating device according to the embodiment of the present disclosure. In FIGS. 8 and 9, the left graph shows the color information output from the optical sensor 138 before calibration is performed, and the right graph shows the color information output from the optical sensor 138 after calibration is performed.

Referring to FIG. 7, the controller 12 may calibrate the optical sensor 138 based on the color information output from the optical sensor 138. The controller 12 may compare the color information output from the optical sensor 138 with a preset sensing range. The controller 12 may determine the intensity of the output light from the optical sensor 138 such that the color information output from the optical sensor 138 is included in the preset sensing range.

The controller 12 may receive the color information output from the optical sensor 138 (S710). The optical sensor 138 may receive light reflected by the stick S received in the insertion space 43 and may output the color information in response thereto. The controller 12 may receive the color information output in response to the light reflected by the stick S.

The controller 12 may compare the color information output from the optical sensor 138 with the preset sensing range. The light receiving portion 1382 of the optical sensor 138 may detect light with light intensity within a certain range. The sensing range may be set to be less than the range defined between the minimum and maximum values of the light intensity value output from the light receiving portion 1382 or the range defined between the minimum and maximum values of the gray level output from the light receiving portion 1382. For example, the upper limit UL1 of the sensing range may be set to be less by a certain value than the maximum value of the light intensity value output from the light receiving portion 1382 or the maximum value of the gray level. For example, the lower limit of the sensing range may be set to be greater by a certain value than the minimum value of the light intensity value output from the light receiving portion 1382 or the minimum value of the gray level. The controller 12 may compare the color information output from the optical sensor 138 with the upper limit UL1 of the sensing range.

The controller 12 may determine the intensity of the output light from the optical sensor 138 such that the intensity of the output light is maximized within a range where the color information output from the optical sensor 138 is equal to or less than the upper limit UL1 of the sensing range.

If the color information output from the optical sensor 138 is equal to the upper limit UL1 of the sensing range (“Yes” of S720), the controller 12 may not change the intensity of the output light from the optical sensor 138. The optical sensor 138 may emit light with the current output light intensity and may receive reflected light to output the color information.

If the color information output from the optical sensor 138 is less than the upper limit UL1 of the sensing range (“Yes” of S730), the controller 12 may control the optical sensor 138 such that the intensity of the output light from the optical sensor 138 increases (S740).

Referring to FIG. 8, the color information output from the optical sensor 138 may include light intensity values or gray levels corresponding to the plurality of colors. For example, the color information may include light intensity values R1, G1, and B1 corresponding to red, green, and blue. The controller 12 may compare each of the plurality of light intensity values R1, G1, and B1 included in the color information with the upper limit UL1 of the sensing range.

The controller 12 may identify the largest value G1 (FIG. 8) among the plurality of light intensity values R1, G1, and B1. The controller 12 may control the optical sensor 138 such that the intensity of the output light from the optical sensor 138 increases if the identified largest value G1 is less than the upper limit UL1 of the sensing range. The controller 12 may determine the difference LD between the largest value G1 among the plurality of light intensity values R1, G1, and B1 and the upper limit UL1 of the sensing range, and may increase the intensity of the output light in proportion to the determined difference LD.

For example, the controller 12 may increase the intensity of the output light by a certain level based on the determined difference LD. The intensity of the light emitted from the light source 1381 of the optical sensor 138 may be determined based on an input pulse width modulation (PWM) signal. The larger the duty ratio of the input PWM signal, the larger the intensity of the output light, and the smaller the duty ratio of the input PWM signal, the smaller the intensity of the output light. The controller 12 may determine the duty ratio of the PWM signal such that the intensity of the output light increases by a certain level. The controller 12 may change the intensity of the light output from the light source 1381 of the optical sensor 138 based on the determined duty ratio. The controller 12 may repeatedly perform the process of receiving the color information output from the optical sensor 138 (S710), comparing the color information output from the optical sensor 138 with the upper limit UL1 of the sensing range, and changing the intensity of the output light.

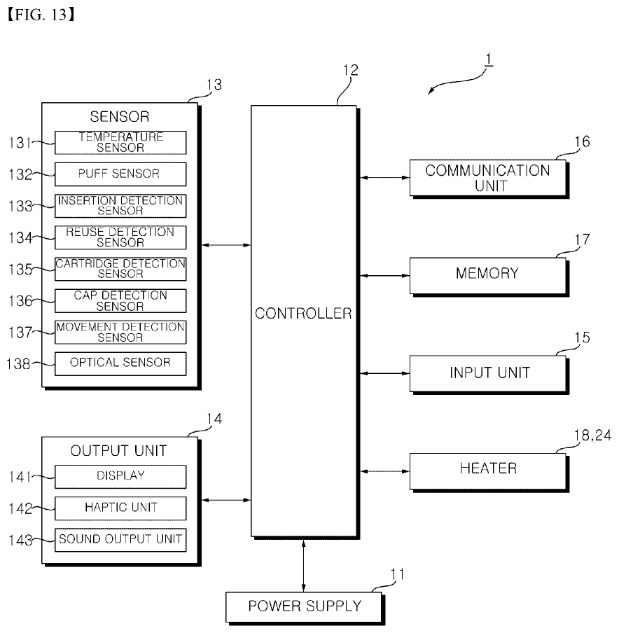

For example, the controller 12 may increase the intensity of the output light such that the largest value G1 among the plurality of light intensity values R1, G1, and B1 increases by the determined difference LD. The controller 12 may determine the duty ratio of the PWM signal in proportion to the determined difference LD. A memory 17 (see FIG. 13) may store information on the amount of increase in the light intensity values or the gray levels corresponding to the plurality of colors output from the optical sensor 138 due to an increase in intensity of the output light. The controller 12 may control the optical sensor 138 such that the intensity of the output light increases based on the information stored in the memory 17. The controller 12 may increase the duty ratio of the PWM signal such that the intensity of the output light can increase by the determined difference LD.

After calibration is performed, the color information output from the optical sensor 138 may be equal to the upper limit UL1 of the sensing range. After calibration is performed, the largest value G1′ among a plurality of light intensity values R1′, G1′, and B1′ included in the color information output from the optical sensor 138 may be equal to the upper limit UL1 of the sensing range.

If the color information output from the optical sensor 138 is greater than the upper limit UL1 of the sensing range (“No” of S730), the controller 12 may control the optical sensor 138 such that the intensity of the output light from the optical sensor 138 decreases (S740).

Referring to FIG. 9, the controller 12 may compare each of a plurality of light intensity values R2, G2, and B2 included in the color information with the upper limit UL1 of the sensing range. The controller 12 may identify the largest value G2 (FIG. 9) among the plurality of light intensity values R2, G2, and B2. The controller 12 may control the optical sensor 138 such that the intensity of the output light from the optical sensor 138 decreases if the identified largest value G2 is greater than the upper limit UL1 of the sensing range. The controller 12 may determine the difference LD between the largest value G2 among the plurality of light intensity values R2, G2, and B2 and the upper limit UL1 of the sensing range, and may reduce the intensity of the output light in proportion to the determined difference LD.

After calibration is performed, the color information output from the optical sensor 138 may be equal to the upper limit UL1 of the sensing range. After calibration is performed, the largest value G2′ among a plurality of light intensity values R2′, G2′, and B2′ included in the color information output from the optical sensor 138 may be equal to the upper limit UL1 of the sensing range.

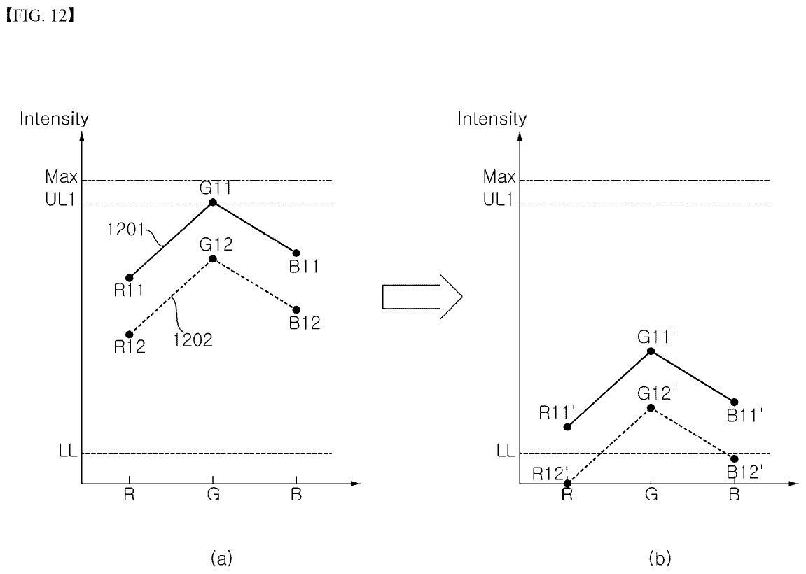

If the color information output from the optical sensor 138 is greater than the upper limit UL1 of the sensing range, the color information may be distorted due to sensor noise, etc. of the optical sensor 138. On the other hand, if the color information output from the optical sensor 138 is less by a certain level than the upper limit UL1 of the sensing range, the color information output from the optical sensor 138 may become less than the lower limit LL (see FIG. 12) of the sensing range as the optical sensor 138 ages. In this case, the color information output from the optical sensor 138 may not accurately reflect the ratio of the unique light intensity value of each stick S.

In the aerosol-generating device 1 according to the embodiment of the present disclosure, it is possible to increase the sensing accuracy of the optical sensor by adjusting the intensity of the output light such that the color information output from the optical sensor 138 is equal to or less than the upper limit UL1 of the sensing range. In addition, it is possible to prevent reduction in sensitivity of the optical sensor and to extend the lifespan of the optical sensor.

FIG. 10 is a graph showing calibration of the optical sensor taking into account the color information of the plurality of sticks in the aerosol-generating device according to the embodiment of the present disclosure. In FIG. 10, the left graph shows the color information output from the optical sensor 138 before calibration is performed, and the right graph shows the color information output from the optical sensor 138 after calibration is performed.

Referring to FIG. 10 together with FIG. 7, the aerosol-generating device 1 may identify various types of sticks S. The stick S may include a plurality of sticks with different reflectances for the plurality of colors included in the color information. The controller 12 may determine the intensity of the output light based on the color information output from the optical sensor 138 in response to the light reflected from each of the plurality of sticks.

For example, the stick S may include a first stick, a second stick, and a third stick, which may have different reflectances for the plurality of colors included in the color information. The first stick may have higher reflectances in the order of blue, red, and green. The second stick may have higher reflectances in the order of green, blue, and red. The third stick may have higher reflectances in the order of blue, green, and red.

In the state in which one of the first to third sticks is received in the insertion space 43, the optical sensor 138 may output the color information corresponding to the received stick. The optical sensor 138 may output first to third color information 1001, 1002, and 1003 corresponding to the first to third sticks. The controller 12 may identify the largest first value B4 among a plurality of light intensity values R4, G4, and B4 included in the first color information 1001. The controller 12 may identify the largest second value G5 among a plurality of light intensity values R5, G5, and B5 included in the second color information 1002. The controller 12 may identify the largest third value B6 among a plurality of light intensity values R6, G6, and B6 included in the third color information 1003. The controller 12 may identify the largest value B4 among the first to third values B4, G5, and B6. That is, the controller 12 may identify the largest value among all the light intensity values included in the color information corresponding to the plurality of sticks.

The controller 12 may determine the difference value LD between the identified value B4 and the upper limit UL1 of the sensing range. The controller 12 may increase the intensity of the output light based on the determined difference value LD.

After calibration is performed, the color information output from the optical sensor 138 may be equal to the upper limit UL1 of the sensing range. After calibration is performed, the largest value B4′ among the plurality of light intensity values R4′, G4′, B4′, R5′, G5′, B5′, R6′, G6′, and B6′ included in the color information output from the optical sensor 138 for the plurality of sticks may be equal to the upper limit UL1 of the sensing range.

If a plurality of sticks with different characteristics is compatible with the aerosol-generating device 1, the optical sensor 138 must be accurately calibrated for all of the compatible sticks.

In the aerosol-generating device 1 according to the embodiment of the present disclosure, the intensity of the output light may be adjusted such that the color information output from the optical sensor 138 in response to the light reflected from each of the plurality of sticks is equal to or less than the upper limit UL1 of the sensing range, whereby it is possible to improve sensing accuracy of the optical sensor.

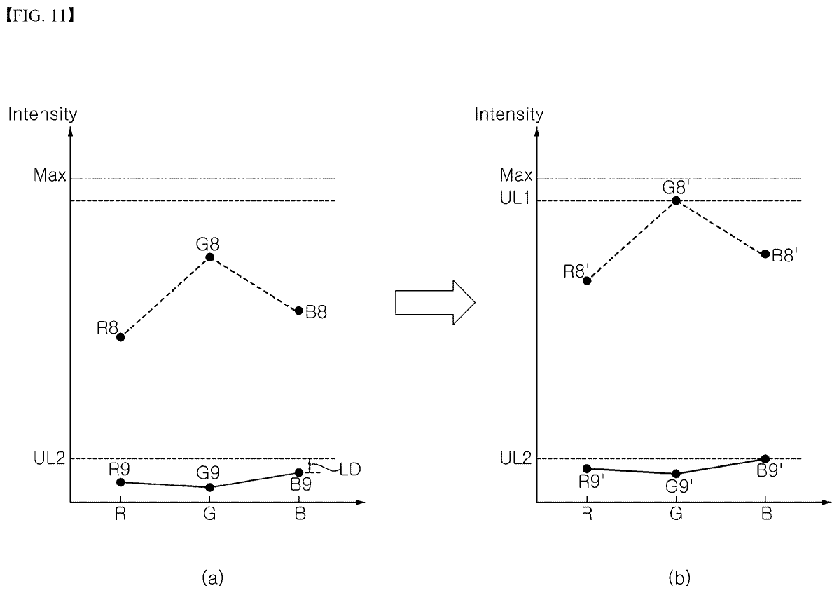

FIG. 11 is a graph showing calibration of the optical sensor without the stick inserted in the aerosol-generating device according to the embodiment of the present disclosure. In FIG. 11, the left graph shows the color information output from the optical sensor 138 before calibration is performed, and the right graph shows the color information output from the optical sensor 138 after calibration is performed.

Referring to FIG. 11 together with FIG. 7, in the state in which the stick S is not received in the insertion space 43, the optical sensor 138 may receive light reflected from the insertion space 43 and may output color information corresponding to the color of the received light. The controller 12 may receive color information output in response to the light reflected from the insertion space 43.

The controller 12 may compare the color information output from the optical sensor 138 with a preset sensing range. The sensing range may include a first upper limit UL1 and a second upper limit UL2. As described above, the first upper limit UL1 may be a reference value for calibrating the intensity of the output light based on the color information output from the optical sensor 138 in response to the light reflected from the stick S. The second upper limit UL2 may be a reference value for calibrating the intensity of the output light based on the color information output from the optical sensor 138 in response to the light reflected from the insertion space 43.

The second upper limit UL2 may be set to correspond to the first upper limit UL1. For example, if the color information output from the optical sensor 138 with the stick S inserted is the same as the first upper limit UL1 of the sensing range, the color information output from the optical sensor 138 without the stick S inserted may be the same as the second upper limit UL2 of the sensing range. That is, if the largest value G8 among a plurality of light intensity values R8, G8, and B8 included in the color information output from the optical sensor 138 with the stick S inserted is equal to the first upper limit UL1, the largest value B9 among a plurality of light intensity values R9, G9, and B9 included in the color information output from the optical sensor 138 without the stick S inserted may be equal to the second upper limit of the sensing range UL2.

The second upper limit UL2 may be set to be less by a certain value than the maximum value of the light intensity value output from the light receiving portion 1382 or the maximum value of the gray level. The second upper limit UL2 may be less than the first upper limit UL1. The controller 12 may compare the color information output from the optical sensor 138 with the second upper limit UL2 of the sensing range.

If the color information output from the optical sensor 138 is less than the second upper limit UL2 of the sensing range, the controller 12 may control the optical sensor 138 such that the intensity of the output light from the optical sensor 138 increases.

The controller 12 may identify the largest value B9 (FIG. 11) among a plurality of light intensity values R9, G9, and B9. The controller 12 may control the optical sensor 138 such that the intensity of the output light from the optical sensor 138 increases if the identified largest value B9 is less than the second upper limit UL2 of the sensing range. The controller 12 may determine the difference LD between the largest value B9 among the plurality of light intensity values R9, G9, and B9 and the second upper limit UL2 of the sensing range, and may increase the intensity of the output light in proportion to the determined difference LD.

If the color information output from the optical sensor 138 is greater than the second upper limit UL2 of the sensing range, the controller 12 may control the optical sensor 138 such that the intensity of the output light from the optical sensor 138 decreases.

The controller 12 may determine the difference LD between the largest value B9 among the plurality of light intensity values R9, G9, and B9 and the second upper limit UL2 of the sensing range, and may reduce the intensity of the output light in proportion to the determined difference LD.

If the color information output from the optical sensor 138 is the same as the second upper limit UL2 of the sensing range, the controller 12 may not change the intensity of the output light from the optical sensor 138.

After calibration is performed, the color information output from the optical sensor 138 without the stick S received in the insertion space 43 may be equal to the second upper limit UL2 of the sensing range. After calibration is performed, the color information output from the optical sensor 138 with the stick S received in the insertion space 43 may be equal to the first upper limit UL1 of the sensing range. After calibration is performed, the largest value G8′ among a plurality of light intensity values R8′, G8′, and B8′ included in the color information output from the optical sensor 138 with the stick S received in the insertion space 43 may be equal to the first upper limit UL1 of the sensing range.

Accordingly, it is possible to adjust the intensity of the output light from the optical sensor 138 without inserting a separate stick S into the insertion space 43.

FIG. 12 is a graph showing a decrease in the sensitivity of the sensor depending on calibration or non-calibration of the optical sensor in the aerosol-generating device according to the embodiment of the present disclosure. In FIG. 12, the left graph shows color information output from the optical sensor 138 at the time when the aerosol-generating device 1 is manufactured, and the right graph shows color information output from the optical sensor 138 after the aerosol-generating device 1 is used for a long time.

Referring to FIG. 12, in the aerosol-generating device 1 according to the embodiment of the present disclosure, if the intensity of the output light from the optical sensor 138 is adjusted (1201), the largest value G11 among a plurality of light intensity values R11, G11, and B11 included in the color information output from the optical sensor 138 at the time the aerosol-generating device 1 is manufactured may be equal to the upper limit UL1 of the sensing range. On the other hand, if the intensity of the output light from the optical sensor 138 is not adjusted (1202), the largest value G12 among a plurality of light intensity values R12, G12, and B12 included in the color information output from the optical sensor 138 may be less by a certain level than the upper limit UL1 of the sensing range.

As described above, the optical sensor 138 may age as the aerosol-generating device 1 is used for a long time. As the use time of the aerosol-generating device 1 increases, the color information output from the optical sensor 138 may become less in value than the color information output from the optical sensor 138 at the time the aerosol-generating device 1 is manufactured. As illustrated in FIG. 12(b), if the color information output from the optical sensor 138 is less than the lower limit LL of the sensing range, the color information output from the optical sensor 138 may not accurately reflect light information reflected from the stick S.

Meanwhile, in the aerosol-generating device 1 according to the embodiment of the present disclosure, if the intensity of the output light from the optical sensor 138 is adjusted, the color information output from the optical sensor 138 may be prevented from becoming less than the lower limit LL of the sensing range even if the optical sensor 138 is aged. Alternatively, the point in time at which the color information output from the optical sensor 138 becomes less than the lower limit LL of the sensing range may be delayed. In other words, in the aerosol-generating device 1 according to the embodiment of the present disclosure, if the intensity of the output light from the optical sensor 138 is adjusted, it is possible to prevent reduction in the sensitivity of the optical sensor 138 and to extend the lifespan of the optical sensor 138.

In the aerosol-generating device 1 according to the embodiment of the present disclosure, the controller 12 may compare the color information output from the optical sensor 138 with the lower limit LL, and may output information related to a sensing error through the output unit 14 if the color information is less than the lower limit LL.

Accordingly, it is possible to improve user convenience.

FIG. 13 is a block diagram of an aerosol-generating device 1 according to an embodiment of the present disclosure.

The aerosol-generating device 1 may include a power supply 11, a controller 12, a sensor 13, an output unit 14, an input unit 15, a communication unit 16, a memory 17, and one or more heaters 18 and 24. However, the internal structure of the aerosol-generating device 1 is not limited to that shown in FIG. 13. That is, it is to be understood by those skilled in the art that some of the components shown in FIG. 13 may be omitted or new components may be added depending on the design of the aerosol-generating device 1.

The sensor 13 may detect the state of the aerosol-generating device 1 or the state of the surrounding of the aerosol-generating device 1 and may transmit information about the detected state to the controller 12. Based on the information about the detected state, the controller 12 may control the aerosol-generating device 1 to perform various functions, such as control of operation of the cartridge heater 24 and/or the heater 18, smoking restriction, determination as to whether the stick S and/or the cartridge 19 is inserted, and notification display.

The sensor 13 may include at least one of a temperature sensor 131, a puff sensor 132, an insertion detection sensor 133, a reuse detection sensor 134, a cartridge detection sensor 135, an cap detection sensor 136, or a movement detection sensor 137.

The temperature sensor 131 may detect temperature to which the cartridge heater 24 and/or the heater 18 is heated. The aerosol-generating device 1 may include a separate temperature sensor configured to detect the temperature of the cartridge heater 24 and/or the heater 18, or the cartridge heater 24 and/or the heater 18 itself may serve as a temperature sensor.

The temperature sensor 131 may output a signal corresponding to the temperature of the cartridge heater 24 and/or the heater 18. For example, the temperature sensor 131 may include a resistive element that changes in resistance value according to a change in temperature of the cartridge heater 24 and/or the heater 18. The temperature sensor may be implemented as a thermistor, which is an element characterized in that the resistance thereof changes with temperature. In this case, the temperature sensor 131 may output a signal corresponding to the resistance value of the resistive element as a signal corresponding to the temperature of the cartridge heater 24 and/or the heater 18. For example, the temperature sensor 131 may be configured as a sensor configured to detect the resistance value of the cartridge heater 24 and/or the heater 18. In this case, the temperature sensor 131 may output a signal corresponding to the resistance value of the cartridge heater 24 and/or the heater 18 as a signal corresponding to the temperature of the cartridge heater 24 and/or the heater 18.

The temperature sensor 131 may be disposed around the power supply 11 to monitor the temperature of the power supply 11. The temperature sensor 131 may be disposed adjacent to the power supply 11. For example, the temperature sensor 131 may be attached to one surface of the battery, which is the power supply 11. For example, the temperature sensor 131 may be mounted on one surface of a printed circuit board.

The temperature sensor 131 may be disposed in the body 10 to detect the internal temperature of the body 10.

The puff sensor 132 may detect a user puff based on various physical changes in a gasflow path. The puff sensor 132 may output a signal corresponding to a puff. For example, the puff sensor 132 may be a pressure sensor. The puff sensor 132 may output a signal corresponding to the internal pressure of the aerosol-generating device. Here, the internal pressure of the aerosol-generating device 1 may correspond to the pressure of the gasflow path through which gas flows. The puff sensor 132 may be disposed at a position corresponding to the gasflow path through which gas flows in the aerosol-generating device 1.

The insertion detection sensor 133 may detect insertion and/or removal of the stick S. The insertion detection sensor 133 may detect a signal change caused by insertion and/or removal of the stick S. The insertion detection sensor 133 may be mounted around the insertion space. The insertion detection sensor 133 may detect insertion and/or removal of the stick S according to a change in dielectric constant in the insertion space. For example, the insertion detection sensor 133 may be an inductive sensor and/or a capacitance sensor.

The inductive sensor may include at least one coil. The coil of the inductive sensor may be disposed adjacent to the insertion space. For example, if a magnetic field changes around a coil through which current flows, the characteristics of the current flowing through the coil may change according to Faraday's law of electromagnetic induction. Here, the characteristics of the current flowing through the coil may include a frequency of alternating current, a current value, a voltage value, an inductance value, an impedance value, and the like.

The inductive sensor may output a signal corresponding to the characteristics of the current flowing through the coil. For example, the inductive sensor may output a signal corresponding to the inductance value of the coil.

The capacitance sensor may include a conductive body. The conductive body of the capacitance sensor may be disposed adjacent to the insertion space. The capacitance sensor may output a signal corresponding to the electromagnetic characteristics of the surroundings, for example, the capacitance around the conductive body. For example, if the stick S including a metallic wrapper is inserted into the insertion space, the electromagnetic characteristics around the conductive body may change due to the wrapper of the stick S. The reuse detection sensor 134 may detect whether the stick S is being reused. The reuse detection sensor 134 may be a color sensor. The color sensor may detect the color of the stick S. The color sensor may detect the color of a portion of the wrapper surrounding the outer side of the stick S. The color sensor may detect, based on light reflected from an object, a value for the optical characteristic corresponding to the color of the object. For example, the optical characteristic may be the wavelength of light. The color sensor may be implemented as a component integrated with a proximity sensor or may be implemented as a component provided separately from a proximity sensor.

At least a portion of the wrapper constituting the stick S may change in color due to an aerosol. The reuse detection sensor 134 may be disposed at a position corresponding to a position at which at least a portion of the wrapper, which changes in color due to an aerosol, is disposed when the stick S is inserted into the insertion space. For example, before the stick S is used by the user, the color of at least a portion of the wrapper may be a first color. In this case, while the aerosol generated by the aerosol-generating device 1 passes through the stick S, at least a portion of the wrapper may become wet due to the aerosol, and accordingly, the color of at least a portion of the wrapper may change to a second color. After changing from the first color to the second color, the color of at least a portion of the wrapper may be maintained in the second color.

The cartridge detection sensor 135 may detect mounting and/or removal of the cartridge 19. The cartridge detection sensor 135 may be implemented as an inductance-based sensor, a capacitive sensor, a resistance sensor, a Hall sensor (or Hall IC) using the Hall effect, etc.

The cap detection sensor 136 may detect mounting and/or removal of the cap. When the cap is separated from the body 10, the cartridge 19 and the portion of the body 10 that have been covered by the cap may be exposed to the outside. The cap detection sensor 136 may be implemented as a contact sensor, a Hall sensor (or Hall IC), an optical sensor, etc.

The movement detection sensor 137 may detect movement of the aerosol-generating device. The movement detection sensor 137 may be implemented as at least one of an acceleration sensor or a gyro sensor.

In addition to the sensors 131 to 137 described above, the sensor 13 may further include at least one of a humidity sensor, a barometric pressure sensor, a magnetic sensor, a position sensor (GPS), or a proximity sensor. The functions of the sensors could be intuitively deduced by those skilled in the art from the names thereof, and thus detailed descriptions thereof will be omitted.

The output unit 14 may output information about the state of the aerosol-generating device 1 and may provide the information to the user. The output unit 14 may include at least one of a display 141, a haptic unit 142, or a sound output unit 143. However, the disclosure is not limited thereto. If the display 141 and a touchpad form a touchscreen together in a layered structure, the display 141 may be used as not only an output device but also an input device.

The display 141 may visually provide information about the aerosol-generating device 1 to the user. For example, the information about the aerosol-generating device 1 may include various pieces of information, such as a charging/discharging state of the power supply 11 of the aerosol-generating device 1, a preheating state of the heater 18, an insertion/removal state of the stick S and/or the cartridge 19, a mounting/removal state of the cap, and a use restriction state of the aerosol-generating device 1 (e.g., detection of an abnormal article), and the display 141 may output the information to the outside. For example, the display 141 may be in the form of a light-emitting diode (LED) device. For example, the display 141 may be a liquid crystal display panel (LCD), an organic light-emitting display panel (OLED), or the like.

The haptic unit 142 may convert an electrical signal into mechanical stimulation or electrical stimulation to haptically provide the information about the aerosol-generating device 1 to the user. For example, if initial power is supplied to the cartridge heater 24 and/or the heater 18 for a predetermined amount of time, the haptic unit 142 may generate vibration corresponding to completion of initial preheating. The haptic unit 142 may include a vibration motor, a piezoelectric element, or an electrical stimulation device.

The sound output unit 143 may audibly provide information about the aerosol-generating device 1 to the user. For example, the sound output unit 143 may convert an electrical signal into an acoustic signal and may output the acoustic signal to the outside.

The power supply 11 may supply power used for operation of the aerosol-generating device 1. The power supply 11 may supply power so that the cartridge heater 24 and/or the heater 18 is heated. In addition, the power supply 11 may supply power necessary for operation of the other components provided in the aerosol-generating device 1, such as the sensor 13, the output unit 14, the input unit 15, the communication unit 16, and the memory 17. The power supply 11 may be a rechargeable battery or a disposable battery. For example, the power supply 11 may be a lithium polymer (LiPoly) battery. However, the disclosure is not limited thereto.

Although not shown in FIG. 13, the aerosol-generating device 1 may further include a power supply protection circuit. The power supply protection circuit may be electrically connected to the power supply 11 and may include a switching element.

The power supply protection circuit may block an electric path to the power supply 11 according to a predetermined condition. For example, the power supply protection circuit may block the electric path to the power supply 11 when the voltage level of the power supply 11 is equal to or higher than a first voltage corresponding to overcharge. For example, the power supply protection circuit may block the electric path to the power supply 11 when the voltage level of the power supply 11 is lower than a second voltage corresponding to overdischarge.

The heater 18 may receive power from the power supply 11 to heat the medium or the aerosol-generating substance in the stick S. Although not shown in FIG. 13, the aerosol-generating device 1 may further include a power conversion circuit (e.g., DC-to-DC converter) configured to convert the power of the power supply 11 and supply the converted power to the cartridge heater 24 and/or the heater 18. In addition, if the aerosol-generating device 1 generates an aerosol in an induction heating way, the aerosol-generating device 1 may further include a DC-to-AC converter configured to convert direct current power of the power supply 11 into alternating current power.

The controller 12, the sensor 13, the output unit 14, the input unit 15, the communication unit 16, and the memory 17 may perform functions using power received from the power supply 11. Although not shown in FIG. 13, the aerosol-generating device may further include a power conversion circuit configured to convert the power of the power supply 11 and supply the converted power to the respective components, for example, a low dropout (LDO) circuit or a voltage regulator circuit. In addition, although not shown in FIG. 13, a noise filter may be provided between the power supply 11 and the heater 18. The noise filter may be a low-pass filter. The low-pass filter may include at least one inductor and a capacitor. The cutoff frequency of the low-pass filter may correspond to the frequency of a high-frequency switching current applied from the power supply 11 to the heater 18. The low-pass filter may prevent high-frequency noise components from being applied to the sensor 13, for example, the insertion detection sensor 133.

In an embodiment, the cartridge heater 24 and/or the heater 18 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome. However, the disclosure is not limited thereto. In addition, the heater 18 may be implemented as a metal wire, a metal plate on which an electrically conductive track is disposed, or a ceramic heating element. However, the disclosure is not limited thereto.

In another embodiment, the heater 18 may be an induction heater. For example, the heater 18 may include a susceptor configured to generate heat through a magnetic field applied by a coil, thereby heating the aerosol-generating substance.

The input unit 15 may receive information input from the user or may output information to the user. For example, the input unit 15 may be a touch panel. The touch panel may include at least one touch sensor configured to detect touch. For example, the touch sensor may include a capacitive touch sensor, a resistive touch sensor, a surface acoustic wave touch sensor, an infrared touch sensor, etc. However, the disclosure is not limited thereto.

The display 141 and the touch panel may be implemented as an integrated panel. For example, the touch panel may be inserted into the display 141 (on-cell type touch panel or in-cell type touch panel). For example, the touch panel may be added onto the display 141 (add-on type touch panel).

Meanwhile, the input unit 15 may include a button, a keypad, a dome switch, a jog wheel, a jog switch, etc. However, the disclosure is not limited thereto.

The memory 17 may be hardware storing various pieces of data processed in the aerosol-generating device 1. The memory 17 may store data processed and to be processed by the controller 12. The memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. The memory 17 may store data on an operation time of the aerosol-generating device 1, the maximum number of puffs, the current number of puffs, at least one temperature profile, and the user's smoking pattern.

The communication unit 16 may include at least one component for communication with other electronic devices. For example, the communication unit 16 may include at least one of a short-range communication unit or a wireless communication unit.

The short-range communication unit may include a Bluetooth communication unit, a Bluetooth low energy (BLE) communication unit, a near-field communication unit, a WLAN (Wi-Fi) communication unit, a Zigbee communication unit, an infrared data association (IrDA) communication unit, a Wi-Fi direct (WFD) communication unit, an ultra-wideband (UWB) communication unit, an Ant+ communication unit, etc. However, the disclosure is not limited thereto.

The wireless communication unit may include a cellular network communication unit, an Internet communication unit, a computer network (e.g., LAN or WAN) communication unit, etc. However, the disclosure is not limited thereto.

Although not shown in FIG. 13, the aerosol-generating device 1 may further include a connection interface such as a universal serial bus (USB) interface, and may be connected to other external devices through the connection interface such as a USB interface to transmit and receive information or charge the power supply 11.

The controller 12 may control overall operation of the aerosol-generating device 1. In an embodiment, the controller 1 may include at least one processor. The processor may be implemented as an array of a plurality of logic gates or may be implemented as a combination of a general-purpose microprocessor and a memory in which a program executable in the microprocessor is stored. Also, it will be understood by those skilled in the art that the processor can be implemented in other forms of hardware.

The controller 12 may control the supply of power from the power supply 11 to the heater 18 to control the temperature of the heater 18. The controller 12 may control the temperature of the cartridge heater 24 and/or the heater 18 based on the temperature of the cartridge heater 24 and/or the heater 18 detected by the temperature sensor 131. The controller 12 may control the power supplied to the cartridge heater 24 and/or the heater 18 based on the temperature of the cartridge heater 24 and/or the heater 18. For example, the controller 12 may determine a target temperature of the cartridge heater 24 and/or the heater 18 based on the temperature profile stored in the memory 17.

The aerosol-generating device 1 may include a power supply circuit (not shown) electrically connected to the power supply 11 between the power supply 11 and the cartridge heater 24 and/or the heater 18. The power supply circuit may be electrically connected to the cartridge heater 24, the heater 18, or the induction coil 181. The power supply circuit may include at least one switching element. The switching element may be implemented as a bipolar junction transistor (BJT), a field effect transistor (FET), or the like. The controller 12 may control the power supply circuit.

The controller 12 may control switching of the switching element of the power supply circuit to control the supply of power. The power supply circuit may be an inverter configured to convert direct current power output from the power supply 11 into alternating current power. For example, the inverter may be composed of a full-bridge circuit or a half-bridge circuit including a plurality of switching elements.

The controller 12 may turn on the switching element so that power is supplied from the power supply 11 to the cartridge heater 24 and/or the heater 18. The controller 12 may turn off the switching element so that the supply of power to the cartridge heater 24 and/or the heater 18 is interrupted. The controller 12 may control the frequency and/or the duty ratio of the current pulse input to the switching element to control the current supplied from the power supply 11.

The controller 12 may control switching of the switching element of the power supply circuit to control the voltage output from the power supply 11. The power conversion circuit may convert the voltage output from the power supply 11. For example, the power conversion circuit may include a buck-converter configured to step down the voltage output from the power supply 11. For example, the power conversion circuit may be implemented as a buck-boost converter, a Zener diode, or the like.

The controller 12 may control on/off operation of the switching element included in the power conversion circuit to control the level of the voltage output from the power conversion circuit. If the switching element is maintained in an on state, the level of the voltage output from the power conversion circuit may correspond to the level of the voltage output from the power supply 11. The duty ratio for the on/off operation of the switching element may correspond to a ratio of the voltage output from the power conversion circuit to the voltage output from the power supply 11. As the duty ratio for the on/off operation of the switching element decreases, the level of the voltage output from the power conversion circuit may decrease. The heater 18 may be heated based on the voltage output from the power conversion circuit.

The controller 12 may control the supply of power to the heater 18 using at least one of a pulse width modulation (PWM) scheme or a proportional-integral-differential (PID) scheme.

For example, the controller 12 may perform control using the PWM scheme such that a current pulse having a predetermined frequency and a predetermined duty ratio is supplied to the heater 18. The controller 12 may control the frequency and the duty ratio of the current pulse to control the power supplied to the heater 18.

For example, the controller 12 may determine, based on the temperature profile, a target temperature to be controlled. The controller 12 may control the power supplied to the heater 18 using the PID scheme, which is a feedback control scheme using a difference value between the temperature of the heater 18 and the target temperature, a value obtained by integrating the difference value with respect to time, and a value obtained by differentiating the difference value with respect to time.

The controller 12 may prevent the cartridge heater 24 and/or the heater 18 from overheating. For example, the controller 12 may control operation of the power conversion circuit such that the supply of power to the cartridge heater 24 and/or the heater 18 is interrupted when the temperature of the cartridge heater 24 and/or the heater 18 exceeds a predetermined limit temperature. For example, the controller 12 may reduce the amount of power supplied to the cartridge heater 24 and/or the heater 18 by a predetermined ratio when the temperature of the cartridge heater 24 and/or the heater 18 exceeds a predetermined limit temperature. For example, when the temperature of the cartridge heater 24 exceeds a limit temperature, the controller 12 may determine that the aerosol-generating substance contained in the cartridge 19 has been exhausted and may interrupt the supply of power to the cartridge heater 24.

The controller 12 may control charging/discharging of the power supply 11. The controller 12 may check the temperature of the power supply 11 based on an output signal from the temperature sensor 131.

If a power line is connected to a battery terminal of the aerosol-generating device 1, the controller 12 may determine whether the temperature of the power supply 11 is equal to or higher than a first limit temperature, which is a reference temperature at which charging of the power supply 11 is interrupted. When the temperature of the power supply 11 is lower than the first limit temperature, the controller 12 may perform control such that the power supply 11 is charged based on a predetermined charging current. When the temperature of the power supply 11 is equal to or higher than the first limit temperature, the controller 12 may interrupt charging of the power supply 11.

When the aerosol-generating device 1 is in an on state, the controller 12 may determine whether the temperature of the power supply 11 is equal to or higher than a second limit temperature, which is a reference temperature at which discharging of the power supply 11 is interrupted. When the temperature of the power supply 11 is lower than the second limit temperature, the controller 12 may perform control such that the power stored in the power supply 11 is used. When the temperature of the power supply 11 is equal to or higher than the second limit temperature, the controller 12 may interrupt use of the power stored in the power supply 11.

The controller 12 may calculate or determine the remaining amount of power stored in the power supply 11. For example, the controller 12 may calculate or determine the remaining capacity of the power supply 11 based on a voltage and/or current detection value of the power supply 11.

The controller 12 may determine whether the stick S is inserted into the insertion space using the insertion detection sensor 133. The controller 12 may determine that the stick S has been inserted based on an output signal from the insertion detection sensor 133. Upon determining that the stick S has been inserted into the insertion space, the controller 12 may perform control such that power is supplied to the cartridge heater 24 and/or the heater 18. For example, the controller 12 may supply power to the cartridge heater 24 and/or the heater 18 based on the temperature profile stored in the memory 17.

The controller 12 may determine whether the stick S is removed from the insertion space. For example, the controller 12 may determine whether the stick S is removed from the insertion space using the insertion detection sensor 133. For example, the controller 12 may determine that the stick S has been removed from the insertion space when the temperature of the heater 18 is equal to or higher than a limit temperature or when the temperature change slope of the heater 18 is equal to or greater than a predetermined slope. Upon determining that the stick S has been removed from the insertion space, the controller 12 may interrupt the supply of power to the cartridge heater 24 and/or the heater 18.

The controller 12 may control a power supply time and/or the amount of power supplied to the heater 18 depending on the state of the stick S detected by the sensor 13. The controller 12 may check, based on a look-up table, a level range within which the level of a signal from the capacitance sensor is included. The controller 12 may determine the amount of moisture in the stick S based on the checked level range.

When the stick S is in a highly humid state, the controller 12 may control a time during which power is supplied to the heater 18 to increase a preheating time of the stick S compared to when the stick S is in a normal state.

The controller 12 may determine whether the stick S inserted into the insertion space is a reused stick using the reuse detection sensor 134. For example, the controller 12 may compare a sensing value of a signal from the reuse detection sensor with a first reference range within which the first color is included, and may determine that the stick S is not a reused stick when the sensing value is within the first reference range. For example, the controller 12 may compare a sensing value of a signal from the reuse detection sensor with a second reference range within which the second color is included, and may determine that the stick S is a reused stick when the sensing value is within the second reference range. Upon determining that the stick S is a reused stick, the controller 12 may interrupt the supply of power to the cartridge heater 24 and/or the heater 18.

The controller 12 may determine whether the cartridge 19 is coupled and/or removed using the cartridge detection sensor 135. For example, the controller 12 may determine whether the cartridge 19 is coupled and/or removed based on a sensing value of a signal from the cartridge detection sensor.

The controller 12 may determine whether the aerosol-generating substance in the cartridge 19 is exhausted. For example, the controller 12 may apply power to preheat the cartridge heater 24 and/or the heater 18, and may determine whether the temperature of the cartridge heater 24 exceeds a limit temperature in a preheating section. When the temperature of the cartridge heater 24 exceeds the limit temperature, the controller 12 may determine that the aerosol-generating substance in the cartridge 19 has been exhausted. Upon determining that the aerosol-generating substance in the cartridge 19 has been exhausted, the controller 12 may interrupt the supply of power to the cartridge heater 24 and/or the heater 18.

The controller 12 may determine whether use of the cartridge 19 is possible. For example, upon determining, based on the data stored in the memory 17, that the current number of puffs is equal to or greater than the maximum number of puffs set for the cartridge 19, the controller 12 may determine that use of the cartridge 19 is impossible. For example, when a total time period during which the cartridge heater 24 is heated is equal to or longer than a predetermined maximum time period or when the total amount of power supplied to the cartridge heater 24 is equal to or greater than a predetermined maximum amount of power, the controller 12 may determine that use of the cartridge 19 is impossible.

The controller 12 may make a determination as to a user puff using the puff sensor 132. For example, the controller 12 may determine, based on a sensing value of a signal from the puff sensor, whether a puff occurs. For example, the controller 12 may determine the intensity of a puff based on a sensing value of a signal from the puff sensor 132. When the number of puffs reaches a predetermined maximum number of puffs or when no puff is detected for a predetermined time period or longer, the controller 12 may interrupt the supply of power to the cartridge heater 24 and/or the heater 18.

The controller 12 may determine whether the cap is coupled and/or removed using the cap detection sensor 136. For example, the controller 12 may determine, based on a sensing value of a signal from the cap detection sensor, whether the cap is coupled and/or removed.

The controller 12 may control the output unit 14 based on a result of detection by the sensor 13. For example, when the number of puffs counted through the puff sensor 132 reaches a predetermined number, the controller 12 may notify the user that operation of the aerosol-generating device 1 will end soon through at least one of the display 141, the haptic unit 142, or the sound output unit 143. For example, upon determining that the stick S is not present in the insertion space, the controller 12 may notify the user of the determination result through the output unit 14. For example, upon determining that the cartridge 19 and/or the cap has not been mounted, the controller 12 may notify the user of the determination result through the output unit 14. For example, the controller 12 may transmit information about the temperature of the cartridge heater 24 and/or the heater 18 to the user through the output unit 14.

Upon determining that a predetermined event has occurred, the controller 12 may store a history of the corresponding event in the memory 17 and may update the history. The event may include events performed in the aerosol-generating device 1, such as detection of insertion of the stick S, commencement of heating of the stick S, detection of puff, termination of puff, detection of overheating of the cartridge heater 24 and/or the heater 18, detection of application of overvoltage to the cartridge heater 24 and/or the heater 18, termination of heating of the stick S, on/off operation of the aerosol-generating device 1, commencement of charging of the power supply 11, detection of overcharging of the power supply 11, and termination of charging of the power supply 11. The history of the event may include the occurrence date and time of the event and log data corresponding to the event. For example, when the predetermined event is detection of insertion of the stick S, the log data corresponding to the event may include data on a value detected by the insertion detection sensor 133. For example, when the predetermined event is detection of overheating of the cartridge heater 24 and/or the heater 18, the log data corresponding to the event may include data on the temperature of the cartridge heater 24 and/or the heater 18, the voltage applied to the cartridge heater 24 and/or the heater 18, and the current flowing through the cartridge heater 24 and/or the heater 18.

The controller 12 may perform control for formation of a communication link with an external device such as a user's mobile terminal. Upon receiving data on authentication from an external device via the communication link, the controller 12 may release restriction on use of at least one function of the aerosol-generating device 1. Here, the data on authentication may include data indicating completion of user authentication for the user corresponding to the external device. The user may perform user authentication through the external device. The external device may determine, based on the user's birthday or an identification number indicating the user, whether the user data is valid, and may receive data on the authority for use of the aerosol-generating device 1 from an external server. The external device may transmit data indicating completion of user authentication to the aerosol-generating device 1 based on the data on the use authority. When the user authentication is completed, the controller 12 may release restriction on use of at least one function of the aerosol-generating device 1. For example, when the user authentication is completed, the controller 12 may release restriction on use of a heating function for supplying power to the heater 18.

The controller 12 may transmit data on the state of the aerosol-generating device 1 to the external device through the communication link established with the external device. Based on the received state data, the external device may output the remaining capacity of the power supply 11 or the operation mode of the aerosol-generating device 1 through a display of the external device.

The external device may transmit a location search request to the aerosol-generating device 1 based on an input for commencement of search for the location of the aerosol-generating device 1. Upon receiving the location search request from the external device, the controller 12 may perform control, based on the received location search request, such that at least one of the output devices performs operation corresponding to location search. For example, the haptic unit 142 may generate vibration in response to the location search request. For example, the display 141 may output objects corresponding to location search and termination of search in response to the location search request.

Upon receiving firmware data from the external device, the controller 12 may perform control such that the firmware is updated. The external device may check the current version of the firmware of the aerosol-generating device 1 and may determine whether there is a new version of firmware. Upon receiving an input requesting firmware download, the external device may receive new version of firmware data and may transmit the new version of firmware data to the aerosol-generating device 1. Upon receiving the new version of firmware data, the controller 12 may perform control such that the firmware of the aerosol-generating device 1 is updated.

The controller 12 may transmit data on a value detected by the at least one sensor 13 to an external server (not shown) through the communication unit 16, and may receive, from the server, and store a learning model generated by learning the detected value through machine learning such as deep learning. The controller 12 may perform operation of determining the user's puff pattern and operation of generating the temperature profile using the learning model received from the server. The controller 12 may store data on the value detected by the at least one sensor 13 and data for training an artificial neural network (ANN) in the memory 17. For example, the memory 17 may store a database for each of the components provided in the aerosol-generating device 1 and weights and biases constituting the structure of the artificial neural network (ANN) in order to train the artificial neural network (ANN). The controller 12 may learn data on the value detected by the at least one sensor 13, the user's puff pattern, and the temperature profile, which are stored in the memory 17, and may generate at least one learning model used to determine the user's puff pattern and to generate the temperature profile.

As described above, according to at least one of the embodiments of the present disclosure, the intensity of the output light from the optical sensor may be calibrated such that the color information output from the optical sensor is included within the set sensing range, whereby it is possible to improve sensing accuracy of the optical sensor.

According to at least one of the embodiments of the present disclosure, the intensity of the output light from the optical sensor may be calibrated such that the intensity of the output light is maximized within the range where the color information output from the optical sensor is equal to or less than the upper limit of the sensing range, whereby it is possible to prevent reduction in sensitivity of the optical sensor and to extend the lifespan of the optical sensor.

According to at least one of the embodiments of the present disclosure, the intensity of the output light may be calibrated based on the color information output from the optical sensor in response to the light reflected from each of the plurality of sticks with different reflectances, whereby it is possible to improve sensing accuracy of the optical sensor.

According to at least one of the embodiments of the present disclosure, the type of the stick received in the device may be identified based on the ratio in the light intensity information between the plurality of colors output from the optical sensor, whereby it is possible to accurately identify the stick received in the device.

Referring to FIGS. 1 to 13, an aerosol-generating device 1 according to one aspect of the present disclosure includes a body 10 having an insertion space 43, an optical sensor 138 disposed adjacent to the insertion space 43, and a controller 12 configured to calibrate the optical sensor 138 based on color information output from the optical sensor 138, wherein the controller 12 may be configured to compare the color information output from the optical sensor 138 with a preset sensing range and determine the intensity of the output light from the optical sensor 138 such that the color information output from the optical sensor 138 is within the sensing range.

In addition, in accordance with another aspect of the present disclosure, the sensing range may include an upper limit UL1 and UL2, and the controller 12 may be configured to determine the intensity of the output light from the optical sensor 138 such that the intensity of the output light is maximized within a range where the color information output from the optical sensor 138 is equal to or less than the upper limit UL1 and UL2.

In addition, in accordance with another aspect of the present disclosure, the color information may include light intensity values corresponding to a plurality of colors, and the controller 12 may be configured to determine the intensity of the output light such that each of the light intensity values corresponding to the plurality of colors is equal to or less than the upper limit UL1 and UL2.

In addition, in accordance with another aspect of the present disclosure, the optical sensor 138 may be configured to receive light reflected by a stick S accommodated in the insertion space 43, and the controller 12 may be configured to determine the intensity of the output light based on the color information output from the optical sensor 138 in response to the light reflected by the stick S.

In addition, in accordance with another aspect of the present disclosure, the stick S may include a plurality of sticks each having a different reflectance for each of the plurality of colors included in the color information, and the controller 12 may be configured to determine the intensity of the output light based on the color information output from the optical sensor 138 in response to the light reflected by each of the plurality of sticks.

In addition, in accordance with another aspect of the present disclosure, the optical sensor 138 may be configured to receive reflected light in the state in which the stick S is not accommodated in the insertion space 43, and the controller 12 may be configured to determine the intensity of the output light based on the color information output from the optical sensor 138 in response to the reflected light.

In addition, in accordance with another aspect of the present disclosure, the controller 12 may be configured to reduce the intensity of the output light based on the color information output from the optical sensor 138 being greater than the upper limit UL1 and UL2, and increase the intensity of the output light based on the color information output from the optical sensor 138 being less than the upper limit UL1 and UL2.

In addition, in accordance with another aspect of the present disclosure, the controller 12 may be configured to determine the difference LD between the color information output from the optical sensor 138 and the upper limit UL1 and UL2 and may reduce or increase the intensity of the output light in proportion to the determined difference LD.

In addition, in accordance with another aspect of the present disclosure, the controller 12 may be configured to determine the duty ratio corresponding to the determined intensity of the output light, and control the optical sensor 138 based on the determined duty ratio.

In addition, in accordance with another aspect of the present disclosure, the controller 12 may be configured to identify the stick S accommodated in the insertion space 43 based on the color information output from the optical sensor 138.

In addition, in accordance with another aspect of the present disclosure, the color information may include light intensity values corresponding to a plurality of colors, and the controller 12 may be configured to determine the relative ratio between the light intensity values corresponding to the plurality of colors included in the color information, and identify the stick S accommodated in the insertion space 43 based on the determined ratio.

In addition, in accordance with another aspect of the present disclosure, the stick S may include a plurality of sticks S1 and S2 each having a different reflectance for each of the plurality of colors, and the controller 12 may be configured to identify the type of the stick accommodated in the insertion space 43 among the plurality of sticks S1 and S2 based on the determined ratio.

In addition, in accordance with another aspect of the present disclosure, the aerosol-generating device may further include an output unit 14, wherein the sensing range may include a lower limit LL, and the controller 12 may be configured to compare the color information output from the optical sensor 138 with the lower limit LL, and output information related to a sensing error through the output unit 14 based on the color information being less than the lower limit LL.

In addition, in accordance with another aspect of the present disclosure, the upper limit UL1 and UL2 may be less than the maximum value of the color information output from the optical sensor 138, and the lower limit LL may be greater than the minimum value of the color information output from the optical sensor 138.

In addition, in accordance with another aspect of the present disclosure, the optical sensor 138 may include a light source 1381 configured to emit light and a light receiving portion 1382 configured to receive light reflected externally from the emitted light.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in an embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

The above detailed description should not be construed as restrictive in all respects but should be considered as illustrative. The scope of the present disclosure should be determined by reasonable interpretation of the appended claims, and all changes within the equivalent scope of the present disclosure are embraced within the scope of the present disclosure.

What is claimed is:

1. An aerosol-generating device comprising:
a body having an insertion space;
an optical sensor disposed adjacent to the insertion space; and
a controller configured to calibrate the optical sensor based on color information output from the optical sensor, wherein
the controller is configured to:
compare the color information output from the optical sensor with a preset sensing range; and
determine intensity of output light from the optical sensor such that the color information output from the optical sensor is within the sensing range.

2. The aerosol-generating device according to claim 1, wherein
the sensing range comprises an upper limit, and
the controller is configured to determine the intensity of the output light from the optical sensor such that the intensity of the output light is maximized within a range where the color information output from the optical sensor is equal to or less than the upper limit.

3. The aerosol-generating device according to claim 2, wherein
the color information comprises light intensity values corresponding to a plurality of colors, and
the controller is configured to determine the intensity of the output light such that each of the light intensity values corresponding to the plurality of colors is equal to or less than the upper limit.

4. The aerosol-generating device according to claim 2, wherein
the optical sensor is configured to receive light reflected by a stick accommodated in the insertion space, and
the controller is configured to determine the intensity of the output light based on the color information output from the optical sensor in response to the light reflected by the stick.

5. The aerosol-generating device according to claim 4, wherein
the stick comprises a plurality of sticks each having a different reflectance for each of the plurality of colors included in the color information, and
the controller is configured to determine the intensity of the output light based on the color information output from the optical sensor in response to the light reflected by each of the plurality of sticks.

6. The aerosol-generating device according to claim 1, wherein
the optical sensor is configured to receive reflected light in a state in which no stick is accommodated in the insertion space, and
the controller is configured to determine the intensity of the output light based on the color information output from the optical sensor in response to the reflected light.

7. The aerosol-generating device according to claim 2, wherein the controller is configured to:
reduce the intensity of the output light based on the color information output from the optical sensor being greater than the upper limit; and
increase the intensity of the output light based on the color information output from the optical sensor being less than the upper limit.

8. The aerosol-generating device according to claim 7, wherein the controller is configured to:
determine a difference between the color information output from the optical sensor and the upper limit; and
reduce or increase the intensity of the output light in proportion to the determined difference.

9. The aerosol-generating device according to claim 1, wherein the controller is configured to:
determine a duty ratio corresponding to the determined intensity of the output light; and
control the optical sensor based on the determined duty ratio.

10. The aerosol-generating device according to claim 1, wherein the controller is configured to identify a stick accommodated in the insertion space based on the color information output from the optical sensor.

11. The aerosol-generating device according to claim 10, wherein
the color information comprises light intensity values corresponding to a plurality of colors, and
the controller is configured to:
determine a relative ratio between the light intensity values corresponding to the plurality of colors included in the color information; and
identify the stick accommodated in the insertion space based on the determined ratio.

12. The aerosol-generating device according to claim 11, wherein
the stick comprises a plurality of sticks each having a different reflectance for each of the plurality of colors, and
the controller is configured to identify a type of the stick accommodated in the insertion space among the plurality of sticks based on the determined ratio.

13. The aerosol-generating device according to claim 2, further comprising:
an output unit, wherein
the sensing range comprises a lower limit, and
the controller is configured to:
compare the color information output from the optical sensor with the lower limit; and
output information related to a sensing error through the output unit based on the color information being less than the lower limit.

14. The aerosol-generating device according to claim 13, wherein
the upper limit is less than a maximum value of the color information output from the optical sensor, and
the lower limit is greater than a minimum value of the color information output from the optical sensor.

15. The aerosol-generating device according to claim 1, wherein the optical sensor comprises:
a light source configured to emit light; and
a light receiving portion configured to receive light reflected externally from the emitted light.
